(19) United States
(12) Patent Application Publication
(10) Pub. No.: US 2013/0300709 A1
(43) Pub. Date: Nov. 14, 2013

(54) INFORMATION PROCESSING DEVICE AND INPUT DEVICE

(71) Applicant: KABUSHIKI KAISHA TOKAI RIKA DENKI SEISAKUSHO, Aichi (JP)

(72) Inventor: Shuri ARAKAWA, Aichi (JP)

(73) Assignee: Kabushiki Kaisha Tokai Rika Denki Seisakusho, Aichi (JP)

(21) Appl. No.: 13/866,099

(22) Filed: Apr. 19, 2013

(30) Foreign Application Priority Data
May 8, 2012 (JP) 2012-106554

(51) Int. Cl. G06F 3/044

(52) U.S. Cl. CPC G06F 3/044
USPC 345/174

(57) ABSTRACT

An information processing device includes an input device including a plurality of touch pads configured to each detect a touch to a detection surface so as to output an operation signal independently of each other, and a control part configured to output a first control signal based on an operation signal if the operation signal is inputted through one of the plurality of touch pads, and to output a second control signal that is different from the first control signal based on the combination of a plurality of operation signals if the plurality of operation signals are inputted through the plurality of touch pads.

The present application is based on Japanese patent application No. 2012-106554 filed on May 8, 2012, the entire contents of which are incorporated herein by reference.

### BACKGROUND OF THE INVENTION

1. Field of the Invention

This invention relates to an information processing device and an input device used for the information processing device.

2. Description of the Related Art

As a conventional technique, an input device 1 is known that includes a touch pad configured to indicate a coordinate on a display screen and a selection switch configured to select an icon or the like in the coordinate indicated (for example, refer to JP-A-H11-039093).

The input device is configured to include a display screen configured to be disposed in the front of the housing and display a coordinate indication tool such as a pointer, a touch pad configured to be disposed in the opposite surface to the display screen of the housing and indicate a coordinate of the coordinate indication tool, and a selection switch configured to be disposed in the side surface of the housing and select an icon or the like in the coordinate indicated by the coordinate indication tool, and is configured such that an operator is able to carry out a plurality of operations by the combination of operations of the touch pad and the selection switch in one hand, in particular, by operating the touch pad by the index finger of the operator or the like and operating the selection switch by the thumb of the operator.

### SUMMARY OF THE INVENTION

The input device shown in JP-A-H11-039093 is configured such that the selection switch outputs only two signals, ON and OFF. Thus only two types of combinations of the signals outputted from the selection switch and the touch pad can be obtained.

Accordingly, it is an object of the invention to provide an information processing device and an input device that can increase the kind of operation to be inputted thereto as compared to the conventional device.

(1) According to one embodiment of the invention, an information processing device comprises:

an input device comprising a plurality of touch pads configured to each detect a touch to a detection surface so as to output an operation signal independently of each other; and

a control part configured to output a first control signal based on an operation signal if the operation signal is inputted through one of the plurality of touch pads, and to output a second control signal that is different from the first control signal based on the combination of a plurality of operation signals if the plurality of operation signals are inputted through the plurality of touch pads.

In the above embodiment (1) of the invention, the following modifications and changes can be made.

(i) The detection surface of the plurality of touch pads is arranged to be non-parallel to each other.

(ii) The detection surfaces of the plurality of touch pads are arranged to be non-parallel to an installation surface on which the input device is mounted.

(2) According to another embodiment of the invention, an information processing device comprises:

a plurality of touch pads configured to each detect a touch to a detection surface arranged to be non-parallel to each other so as to output an operation signal independently of each other.

In the above embodiment (2) of the invention, the following modifications and changes can be made.

(iii) The input device further comprises a palm rest disposed on a flat portion parallel to an installation surface on which the input device is mounted,

wherein the detection surface of the plurality of touch pads defines an angle relative to the flat portion, the angle being different from each other.

(iv) The plurality of touch pads comprises two touch pads,

wherein the two touch pads are disposed such that one side of the detection surface is to contact with each other and the one side of the detection surface forms a convex portion by being elevated relative to another side of the detection surface.

(v) The plurality of touch pads comprises two touch pads, wherein the two touch pads are disposed to sandwich another member between one sides of the detection surface.

(vi) The two touch pads are disposed such that the one side of the detection surface forms a convex portion by being elevated relative to another side of the detection surface.

Effects of the Invention

According to one embodiment of the invention, an information processing device and an input device can be provided that can increase the kind of operation to be inputted thereto as compared to the conventional device.

### BRIEF DESCRIPTION OF THE DRAWINGS

The preferred embodiments according to the invention will be explained below referring to the drawings, wherein:

FIG. 1A is a perspective view schematically showing an information processing device and an input device according to one embodiment of the invention;

FIG. 1B is a side view schematically showing the input device according to the embodiment of the invention;

FIG. 1C is a flat view schematically showing the input device according to the embodiment of the invention;

FIG. 2 is a block diagram showing one example of the configuration of the information processing device and the input device according to the embodiment of the invention;

FIGS. 3(a1) to 3(a6), FIGS. 3(b1) to 3(b6), FIG. 3(c1) and FIG. 3(c5) are explanatory views showing a series of operation flows for selecting and moving icons displayed on a display screen of a display part of the information processing device;

FIGS. 4(a1) to 4(a3) and FIGS. 4(b1) to 4(b3) are explanatory views showing a series of operation flows for enlarging images displayed on a display screen of a display part of the information processing device; and

FIGS. 5(a1) to 5(a3) and FIGS. 5(b1) to 5(b3) are explanatory views showing a series of operation flows for reducing images in size displayed on a display screen of a display part of the information processing device.

### DETAILED DESCRIPTION OF THE PREFERRED EMBODIMENTS

Configuration of Input Device

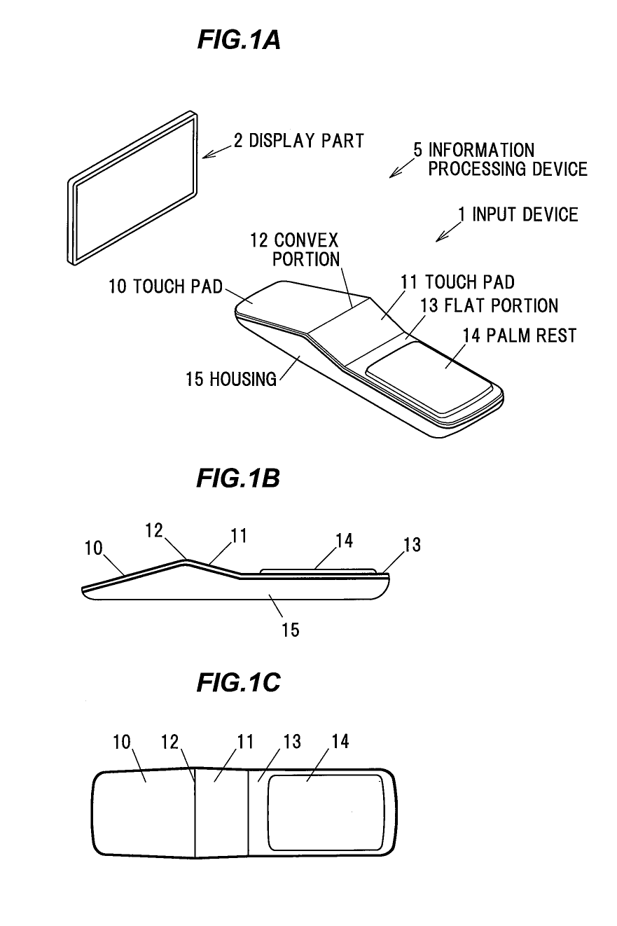

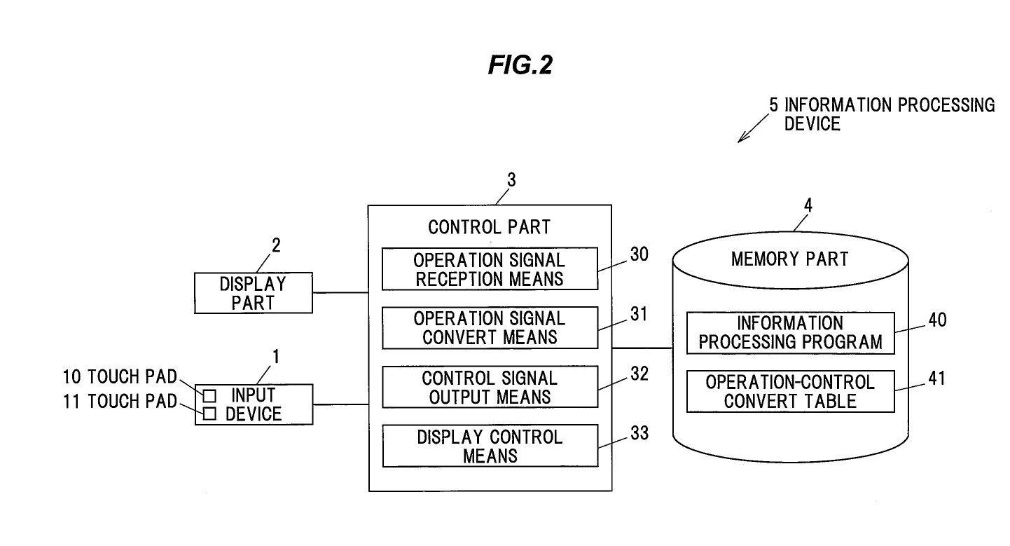

FIG. 1A is a perspective view showing an information processing device and an input device, FIG. 1B is a side view showing the input device, and FIG. 1C is a flat view showing the input device according to the embodiment of the invention. FIG. 2 is a block diagram showing one example of the configuration of the information processing device and the input device according to the embodiment of the invention.

The information processing device 5 includes an input device 1 such as a touch pad configured to output an operation signal based on an input operation of an operator, a display part 2 such as a liquid crystal display (LCD) configured to display characters, images, and the like, a control part 3 configured to include a center processing unit (CPU), a graphic processing unit (GPU) and the like configured to convert an operation signal input from the input device 1 into a control signal, and to output information regarding characters, images and the like to the display part 2 so as to be displayed on the display part 2, and a memory part 4 such as a hard disc drive (HDD) configured to store a program that operates in the control part 3, and conversion information between the operation signal and the control signal. Further, the control part 3 and the memory part 4 are not shown in FIGS. 1A to 1C, but can be configured to be integrated into the input device 1 or the display part 2, and can be also configured to be formed separately therefrom.

The input device 1 is configured to include touch pads 10, 11 to be used for an operation and output an operation signal independently of each other according to the operation, a palm rest 14 to be disposed on a flat portion 13 parallel to an installation surface of the input device 1 so as to hold a palm of the operator, and a housing 15 to cover the lower part of the input device 1 and house electronic parts and the like therein.

The touch pads 10, 11 are arranged to be non-parallel (or not parallel) to the flat portion 13 such that they define an angle relative to the flat portion 13, wherein the angle is different from each other. For example, the touch pads 10, 11 are arranged such that the respective one sides of the detection surfaces thereof come into contact with each other and the one sides are elevated relative to the other sides of the detection surfaces thereof so as to thereby form a convex portion 12. Meanwhile, the touch pads 10, 11 may be configured such that another member is sandwiched between the one sides of the detection surfaces thereof.

The touch pads 10, 11 are comprised of a touch sensor that is configured, for example, if the detection surface thereof is touched with a part (for example, a finger) of the body of the operator, to detect the location on the detection surface touched. The operator, for example, carries out an operation on the detection surface, thereby the operator is able to carry out an operation of the information processing device 5 or/and an external device (not shown) connected to the information processing device 5. As the touch pads 10, 11, for example, a well-known touch panel such as resistance film type, infrared ray type, surface acoustic wave (SAW) type, electrostatic capacitance type touch panel can be used.

The touch pads 10, 11 according to the embodiment is comprised of, for example, an electrostatic capacitance type touch sensor configured to output change in electric current inversely proportional to a distance between an electrode disposed under the detection surface and a finger as detection signal due to the fact that a finger comes close to the operation surface.

The detection surface is, for example, comprised of polyethylene terephthalate (PET) or glass, and formed to have a plate-like shape. The electrode is, for example, comprised of indium tin oxide (ITO), and formed under the detection surface to have a matrix-like shape.

The touch pads 10, 11 are configured to read out the electrostatic capacitance from the electrode according to clock signal internally generated, and generate a coordinate value based on the value of electrostatic capacitance (the electrostatic capacitance value) read out, so as to output the coordinate value to the control part 3 as an operation signal.

The display part 2 is comprised of, for example, a well-known a liquid crystal display (LCD) such as a TFT type LCD. The display part 2 is configured to be connected to the control part 3, and based on information for displaying images output from the control part 3, display the images on a display screen.

The control part 3 allows an information processing program 40 of the memory part 4 to be executed, thereby the control part 3 functions as an operation signal reception means 30, and operation signal convert means 31, a display control means 33, a control signal output means 32 and the like.

The operation signal reception means 30 is configured to receive the operation signal output from the input device 1.

The operation signal convert means 31 is configured to convert the operation signal received by the operation signal reception means 30 into a control signal based on an operation-control convert table 41 described below.

The control signal output means 32 is configured to output the control signal converted by the operation signal convert means 31 to an external device (not shown) or the like connected to the display control means 33 or the information processing device 5 according to the type of the control signal.

The display control means 33 is configured to output information for displaying images on the display part 2. In addition, the display control means 33 is configured to change the information for displaying images on the display part 2 based on the output by the control signal output means 32.

The memory part 4 is configured to store the information processing program 40 configured to allow the control part 3 to function as the above-mentioned respective means 30 to 33, the operation-control convert table 41 configured to define a correspondence relation between the operation signal and the control signal, and the like.

Operation

Hereinafter, the operation of the information processing device 5 will be explained referring to FIGS. 1 to 5 separately about (1) Basic operation, (2) Icon selection operation, and (3) Enlargement and reducing in size operation.

(1) Basic Operation

First, if electric power is supplied to the information processing device 5 from an electric source (not shown), the display control means 33 of the control part 3 displays an initial screen on the display part 2.

Next, the operator carries out some types of operation by touching the touch pads 10, 11 of the input device 1 while watching the initial screen on the display part 2.

The input device 1 detects the location touched by the operator in the detection surfaces of the touch pads 10, 11. The detection of the location is carried out by reading out the electrostatic capacitance from the electrode according to clock signal internally generated, and a coordinate value of the detected location is generated based on the value of electrostatic capacitance read out so as to be output as an operation signal. The operation signal output by the input device 1 is input to the control part 3.

The operation signal reception means 30 of the control part 3 receives the operation signal input. Next, the operation signal convert means 31 converts the operation signal received by the operation signal reception means 30 into a control signal based on the operation-control convert table 41.

Next, the control signal output means 32 of the control part 3 outputs the control signal converted by the operation signal convert means 31 to an external device (not shown) or the like connected to the display control means 33 or the information processing device 5 according to the type of the control signal. Further, the control signal output means 32 outputs the control signal even if the display of the display control means 33 is changed as described below.

The display control means 33, if the control signal is input from the control signal output means 32, changes the information for displaying images on the display part 2 based on the control signal. The particular examples of the change will be explained in the following “(2) Icon selection operation, and (3) Enlargement and reducing in size operation” in detail.

In addition, if the control signal output means 32 outputs the control signal to an external device or the like, the external device or the like operates based on the control signal.

Hereinafter, a relationship between the operation to the input device 1 and the display of the display control means 33 will be explained concretely.

(2) Icon Selection Operation

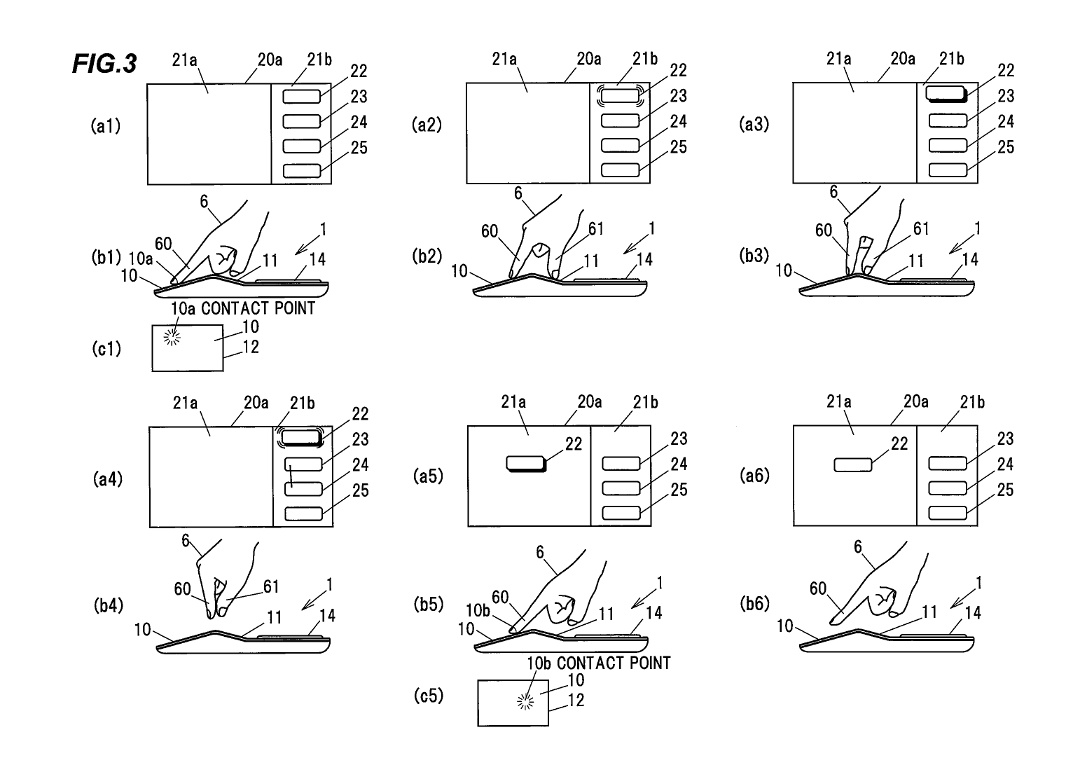

FIGS. 3(a1) to 3(a6), FIGS. 3(b1) to 3(b6), FIG. 3(c1) and FIG. 3(c5) are explanatory views showing a series of operation flows for selecting and moving icons displayed on the display screen of the display part 2 of the information processing device 5.

First, as shown in FIG. 3(i a1), in a display screen 20a of the display part 2, by the display control means 33, as one example of the initial screen, a main screen 21a and a sub screen 21b are displayed, and a plurality of icons 22 to 25 are displayed in the sub screen 21b.

Further, the display screen 20a is a screen configured to decide the arrangement of the icons 22 to 25, and the icons 22 to 25 are configured such that different control signals for controlling the external device are allocated to each of the icons 22 to 25. Namely, if a selection operation is applied to the icons 22 to 25 on an operation screen (not shown) on which the icons 22 to 25 are arranged, the control signal output means 32 of the control part 3 outputs the control signal allocated to each icon.

In a state shown in FIG. 3(i a1), as shown in FIGS. (b1) and (c1), if the operator touches the location (touch point 10a) of the display screen 20a of the detection surface of the touch pad 10 corresponding to the icon 22 with the index finger 60, the icon 22 is indicated.

Further, in the invention, a series of operations from “the touch pad 10 is operated” to “the icon 22 is indicated” are carried out, namely, the input device 1 output the operation signal according to the operation, the operation signal is received by the operation signal reception means 30, the operation signal is converted into the control signal by the operation signal convert means 31, the control signal output means 32 outputs the control signal to the display control means 33, and the display processing is carried out by the display control means 33, however, hereinafter, if the same series of operations are carried out, the overlapped descriptions of the operations will be omitted for the purpose of simplifying the explanation.

Next, as shown in FIG. 3(b1), while maintaining a touch of the index finger 60 to the touch point 10a, as shown in FIG. 3(b2), if the operator 6 touches an arbitrary location on the detection surface of the touch pad 11 with the thumb 61 thereof, as shown in FIG. 3(a2), the display becomes a display configured such that the icon 22 indicated vibrates. Here, the vibrating display exhibits a state that the icon 22 has been selected.

Next, while maintaining a touch of the index finger 60 to the detection surface of the touch pad 10 and a touch of the thumb 61 to the detection surface of the touch pad 11, as shown in FIG. 3(b3), if an operation is carried out so as to narrow the distance between the index finger 60 and the thumb 61, as shown in FIG. 3(a3), the display becomes a display configured such that the icon 22 vibrated floats above the sub screen 21b. Here, the floating display exhibits a state predicting that the icon 22 becomes movable by an operation explained next.

Next, as shown in FIG. 3(b4), if an operation is carried out so as to respectively separate the index finger 60 and the thumb 61 from the detection surfaces of the touch pads 10, 11, as shown in FIG. 3(a4), the display becomes a display configured such that the icon 22 floated above the sub screen 21b floats and vibrates. Here, the floating and vibrating display exhibits a state that the icon 22 has become movable.

Next, as shown in FIG. 3(b5) and FIG. 3(c5), if the operator 6 touches a location (touch point 10b) corresponding to the center of the main screen 21a of the display screen 20a of the detection surface of the touch pad 10 with the index finger 60t thereof, as shown in FIG. 3(a5), the display becomes a display configured such that the icon 22 is arranged in the center of the main screen 21a and floats above the main screen 21a.

Here, the display floating above the main screen 21a exhibits a state that the icon 22 has become able to be arranged.

Next, as shown in FIG. 3(b6), if an operation is carried out so as to separate the index finger 60 from the detection surface of the touch pad 10, as shown in FIG. 3(a6), the icon 22 is arranged in the center of the main screen 21a.

(3) Enlargement and Reducing in Size Operation

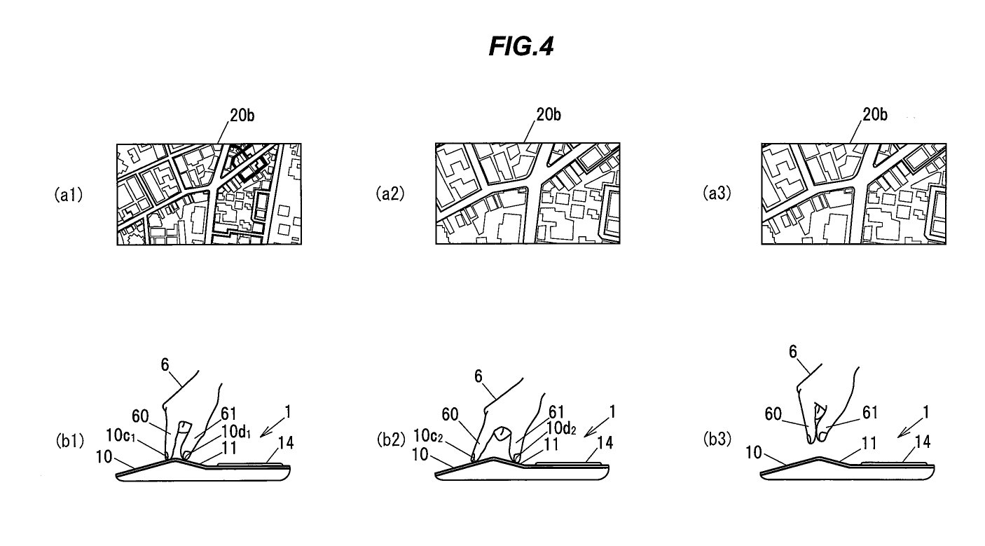

FIGS. 4(a1) to 4(a3) and FIGS. 4(b1) to 4(b3) are explanatory views showing a series of operation flows for enlarging images displayed on a display screen of the display part 2 of the information processing device 5.

First, as shown in FIG. 4(i a1), in the display screen 20b of the display part 2, an image such a map is displayed as the other example of the initial screen.

In the state shown in FIG. 4(i a1), as shown in FIG. 4(b1), if the operator 6 touches an arbitrary location (touch point 10c₁) on the detection surface of the touch pad 10 with the index finger 60 thereof, and touches an arbitrary location (touch point 10d₁) on the detection surface of the touch pad 11 with the thumb 61 thereof, and next, while maintaining a touch of the index finger 60 and a touch of the thumb 61, as shown in FIG. 4(b2), if an operation is carried out so as to expand the distance between the index finger 60 and the thumb 61 (to the distance between the touch point 10c₂ of the index finger 60 and the touch point 10d₂ the thumb 61), as shown in FIG. 4(a2), the image such as the map on the display screen 20b is enlarged at the fold magnification according to the distance expanded.

Next, as shown in FIG. 4(b3), if the index finger 60 and the thumb 61 are respectively separated from the touch point 10c₂ and the touch point 10d₁, the enlargement operation of the image such as the map on the display screen 20b is released.

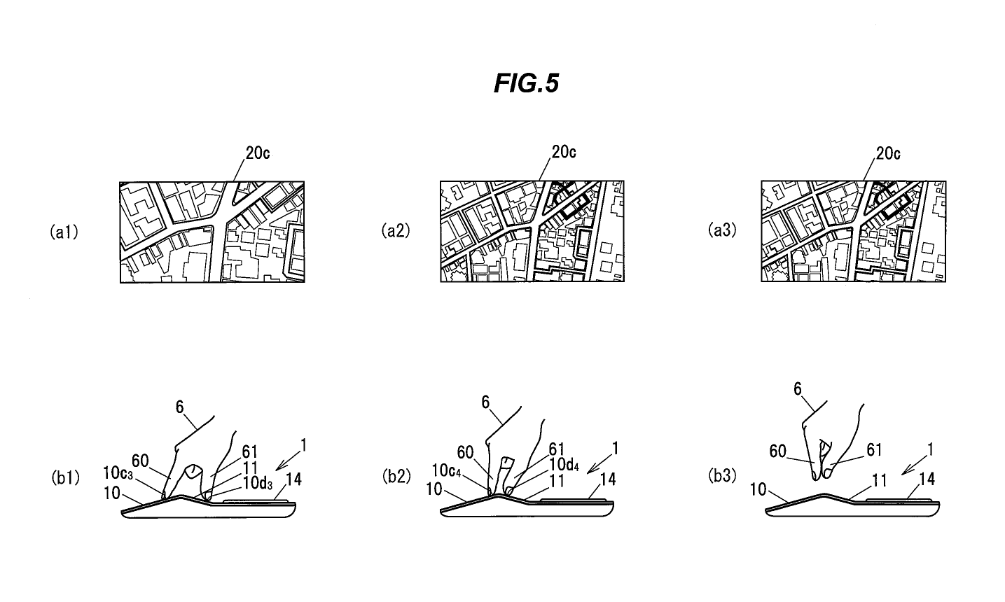

FIGS. 5(a1) to 5(a3) and FIGS. 5(b1) to 5(b3) are explanatory views showing a series of operation flows for reducing images in size displayed on the display screen of the display part 2 of the information processing device 5.

First, as shown in FIG. 5(i a1), in the display screen 20c of the display part 2, an image such a map is displayed as the other example of the initial screen.

In the state shown in FIG. 5(i a1), as shown in FIG. 5(b1), if the operator 6 touches an arbitrary location (touch point 10c₃) on the detection surface of the touch pad 10 with the index finger 60 thereof, and touches an arbitrary location (touch point 10d₃) on the detection surface of the touch pad 11 with the thumb 61 thereof, and next, while maintaining a touch of the index finger 60 and a touch of the thumb 61, as shown in FIG. 5(b2), if an operation is carried out so as to narrow the distance between the index finger 60 and the thumb 61 (to the distance between the touch point 10c₄ of the index finger 60 and the touch point 10d₄ the thumb 61), as shown in FIG. 5(a2), the image such as the map on the display screen 20c is reduced in size at the fold magnification according to the distance narrowed.

Next, as shown in FIG. 5(b3), if the index finger 60 and the thumb 61 are respectively separated from the touch point 10c₄ and the touch point 10d₄, the enlargement operation of the image such as the map on the display screen 20c is released.

Advantages of the Embodiment

According to the above-mentioned embodiment, as explained in “(2) Icon selection operation”, and “(3) Enlargement and reducing in size operation”, if the touch pad 10 is operated singly, the operation signal is converted into the control signal that indicates the coordinate, and if the operation like a pinching action is carried out on the detection surfaces of the touch pads 10, 11, the operation signal is converted into a plurality of control signals other than the indication signal thus the input device 1 can increase the type of operation that the operator can input in comparison with the conventional input device such as an input device configured to use a single touch pad and an operation switch.

In addition, the input device 1 is configured such that the operations of indication and selection can be switched by combining the touch pad 10 and the touch pad 11, thus the operation procedure required for the operations of indication and selection is shortened so as to reduce the time needed for the operations in comparison with a conventional input device configured to, for example, use a single touch pad, and in which the operation is carried out so as to continue the indication for several seconds at the time of selection.

In addition, the input device 1 is configured such that the touch pad 10 and the touch pad 11 are arranged so as to be raised in the direction of the convex portion 12 and to be inclined, the operations like a pinching action and an expanding action can be easily and intuitively carried out. In addition, if the operator has a long nail, the input device 1 prevents the nail from scraping against the detection surface so as to prevent an operation feeling from being easily lost. In addition, the input device 1 is configured to include the convex portion 12, thus the operator can confirm the boundary of the touch pads 10, 11 without visually recognizing the touch pads 10, 11.

In addition, the input device 1 is configured to differentiate the control signal conversion in case that a plurality of touches are carried out in each of the touch pads 10, 11, from the control signal conversion in case that a plurality of touches are simultaneously carried out in both of the touch pads 10, 11, thereby variation of the control signal conversion can be further increased.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth. For example, the touch pads 10, 11 can be configured to be comprised of one touch pad, so as to carry out the detection of touch similar to the touch pads 10, 11 with respect to each touch region.

What is claimed is:

1. An information processing device, comprising:
an input device comprising a plurality of touch pads configured to each detect a touch to a detection surface so as to output an operation signal independently of each other; and
a control part configured to output a first control signal based on an operation signal if the operation signal is inputted through one of the plurality of touch pads, and to output a second control signal that is different from the first control signal based on the combination of a plurality of operation signals if the plurality of operation signals are inputted through the plurality of touch pads.

2. The information processing device according to claim 1, wherein the detection surface of the plurality of touch pads is arranged to be non-parallel to each other.

3. The information processing device according to claim 2, wherein the detection surfaces of the plurality of touch pads are arranged to be non-parallel to an installation surface on which the input device is mounted.

4. An input device, comprising:
a plurality of touch pads configured to each detect a touch to a detection surface arranged to be non-parallel to each other so as to output an operation signal independently of each other.

5. The input device according to claim 4, further comprising a palm rest disposed on a flat portion parallel to an installation surface on which the input device is mounted,
wherein the detection surface of the plurality of touch pads defines an angle relative to the flat portion, the angle being different from each other.

6. The input device according to claim 4, wherein the plurality of touch pads comprises two touch pads,
wherein the two touch pads are disposed such that one side of the detection surface is to contact with each other and the one side of the detection surface forms a convex portion by being elevated relative to another side of the detection surface.

7. The input device according to claim 4, wherein the plurality of touch pads comprises two touch pads,
wherein the two touch pads are disposed to sandwich another member between one sides of the detection surface.

8. The input device according to claim 7, wherein the two touch pads are disposed such that the one side of the detection surface forms a convex portion by being elevated relative to another side of the detection surface.
